(19) United States
(12) Patent Application Publication
(10) Pub. No.: US 2021/0009768 A1
(43) Pub. Date: Jan. 14, 2021

(54) THERMOPLASTIC COMPOSITION

(71) Applicants: DDP SPECIALTY ELECTRONIC MATERIALS US 9, LLC, MIDLAND, MI (US); MULTIBASE S.A., SAINT LAURENT DU POINT (FR)

(72) Inventors: VINCENT RERAT, SENEFFE (BE); YANN GRADELET, SAINT LAURENT DU PONT (FR); SYLVAIN BOUCARD, SAINT LAURENT DU PONT (FR); CLEMENT DESCAMPS, SENEFFE (BE); THIBAULT KERVYN DE MEERENDRE, MIDLAND, MI (US)

(21) Appl. No.: 16/980,029

(22) PCT Filed: Apr. 4, 2019
(86) PCT No.: PCT/US2019/025728

§ 371 Date: Sep. 11, 2020

(30) Foreign Application Priority Data
Apr. 5, 2018 (EP) 18305403.0

(51) Int. Cl. C08J 3/24; C08J 3/22; B29C 45/00

(52) U.S. Cl. CPC C08J 3/246; C08J 3/226; B29C 45/0001; C08J 2483/04; B29L 2031/16; C08L 2207/04; C08J 2355/02; C08J 2369/00; C08L 2310/00

(57) ABSTRACT

This disclosure relates to a shaped article made from thermoplastic material which may be a thermoplastic elastomeric material containing a masterbatch of a stick-slip modifier having one or more thermoplastic silicone vulcanisates, an assembly comprising the article and a process for making the shaped article.

This disclosure relates to a shaped article made from thermoplastic material which may be a thermoplastic elastomeric material containing a masterbatch of a stick-slip modifier having one or more thermoplastic silicone vulcanisates, an assembly comprising the article and a process for making the shaped article.

A Thermoplastic material is a plastic material that becomes pliable or moldable above a specific temperature and solidifies upon cooling. When reheated the thermoplastic material can be remoulded into a new shape. In contrast a thermoset material is a plastic that is irreversibly cured from a soft solid or viscous liquid prepolymer or resin and once cured/ hardened a thermoset material cannot be remoulded into a new shape upon reheating. Thermoplastic polymers, e.g., polyamides, polyesters, polyphenylene sulfide, polyoxymethylene, polyolefins, styrene polymers and polycarbonates, are characterized as exhibiting exceptional mechanical and electrical properties as well as good mouldability and chemical resistance. However, these polymers exhibit inadequate tribological and/or stick-slip properties when utilized in some frictional environments, e.g., plastic to metal, and plastic to plastic interfaces.

Thermoplastic elastomers (TPEs) are polymeric materials which possess both plastic and rubbery properties. As indicated above TPEs can be re-processed at elevated temperatures. This re-process ability is a major advantage of TPEs over chemically crosslinked rubbers since it allows recycling of fabricated parts and results in a considerable reduction of scrap.

In general, two main types of thermoplastic elastomers are known, block copolymer TPEs and simple blend TPEs (physical blends).

Block copolymer TPEs contain
(i) blocks or segments that are called hard or rigid (i.e. having a thermoplastic behaviour), typically have a melting point or glass transition temperature above ambient temperature; and
(ii) blocks or segments that are called soft which are pliable or flexible (i.e. having an elastomeric behaviour) and typically have a low glass transition temperature (Tg) or a melting point considerably below room temperature.
   The expression “low glass transition temperature” is understood to mean a glass transition temperature Tg below 15° C., preferably below 0° C., advantageously below −15° C., more advantageously below −30° C., possibly below −50° C.

In block copolymer thermoplastic elastomers, the hard segments aggregate to form distinct micro phases and act as physical crosslinks for the soft phase, thereby imparting a rubbery character at room temperature. At elevated temperatures, the hard segments melt or soften and allow the copolymer to flow and to be processed. The hard blocks are generally based on polyamides, polyurethanes, polyesters, polystyrene, polyolefins or a mixture of thereof. The soft blocks are generally based on polyethers, polyesters, polyolefins and copolymers or blends thereof.

TPEs referred to as simple blends or physical blends can be obtained by uniformly mixing an elastomeric component with a thermoplastic resin.

Articles, e.g. assembly components, made from thermoplastic polymers are often designed to slide or rub against one or more other components also made from a thermoplastic polymer during movement. The sliding and/or rubbing between adjacent surfaces does not always generate a constant frictional force in which case it tends to oscillate between adhesion and sliding, a phenomenon generally described as “stick-slip”.

The term stick-slip is used to describe the manner in which two opposing surfaces or articles slide over each other in reaction to static and kinetic friction. Static friction is intended to mean the friction between two articles that are not moving relative to each other. For the 2 articles to remain in contact and move relative to each other a force greater than that of static friction must be applied to one of the articles. Kinetic friction is intended to mean the friction created when two objects are moving relative to each other while in contact. The friction between the two surfaces can increase or decrease during movement depending upon numerous factors, including the speed at which movement takes place.

An unfortunate consequence of stick-slip motion is the generation of an audible, often unpleasant, “squeaky” noise when stick-slip occurs. Such noise is particularly undesirable when using consumer appliances or in the interiors of vehicles. Noise generation of this sort is undesirable during use of a product and may prove to be highly irritating and off-putting for a user.

Materials such as fabrics and/or foams are sometimes added to or placed in between e.g. two thermoplastic materials in an effort to avoid noise generation which would otherwise occur. However, this may be expensive and indeed may need complicated adjustments to parts and machinery and is therefore undesirable.

Lubricating compositions have been applied onto thermoplastic polymers to improve friction and wear properties, certain applications prohibited the use of many desirable lubricants because of possible contamination, e.g., food handling, clothing preparation, and volatile environments. Furthermore lubricants have also been incorporated directly into thermoplastic polymers prior to the fabrication of shaped articles therefrom. Many materials in different combinations, including solid lubricants and fibers (e.g., graphite, mica, silica, talc, boron nitride and molybdenum sulfide), paraffin waxes, petroleum and synthetic lubricating oils, and polymers (e.g., polyethylene and polytetrafluoroethylene), have been added to thermoplastic polymers to improve the lubricating properties. Fluoropolymer based coatings are known but are generally expensive, can be difficult to apply and coated end products are often not sufficiently flexible. Recent developments include the commercial availability of “ready to use” “anti-squeak” polycarbonate/acrylonitrile-butadiene-styrene (PC/ABS) grades.

A masterbatch is typically a solid additive for plastic or other polymer which is used to impart desired properties to this plastic or other polymer. A masterbatch is typically a concentrated mixture of additives encapsulated into a carrier resin during a process involving heat, which is then cooled and cut into granular shape. This imparts desired property improvements to a polymer. Masterbatches are typically in solid form at ambient temperature, usually in pelletized format. Siloxane masterbatches are typically pelletized micro-dispersions of siloxane polymers, in various different plastic carrier resins at loadings of up to 50%. Siloxane Masterbatches are produced in solid form for ease of use. They typically contain 25-50% siloxane polymers (generally gums with a viscosity >1 million mm²·s⁻¹ (cSt), typically >15 million mm²·s⁻¹ (cSt)) dispersed with for example an average particle size of 5 μm in various thermoplastics.

Masterbatches of uncured organopolysiloxane polymers in thermoplastics are a proven solution to enhance surface performance of the thermoplastics. Siloxane masterbatches containing high molecular weight siloxane polymer dispersed in various thermoplastic resins have been successfully used in automotive interior and exterior components and in consumer applications such as laptop computers and cellular phone cases, and in tubing and film markets. The siloxane polymer migrates to the surface in the melt phase and gives scratch and mar resistance without the adverse effect of additive exudation of a small molecule additive.

The most commonly used uncured organopolysiloxane polymers are linear PDMS (polydimethylsiloxanes) of various viscosities, ranging from the shortest possible chain, hexamethyldisiloxane with a viscosity of, for example, 0.65 mm²·s⁻¹ (cSt), to polymers with high degrees of polymerization and viscosities over for example 10⁶mm²·s⁻¹ (cSt), often called silicone gums. PDMS gums are usually fluids with viscosity around or higher than 10⁶mm².s⁻¹ (cSt). The viscosity values of high viscosity diorganopolysiloxane polymers (e.g. ≥1000000 mm².s⁻¹ (cSt)) may be measured by using an AR 2000 Rheometer from TA Instruments of New Castle, Del., USA or a suitable Brookfield viscometer using the most appropriate spindle for the viscosity being measured. However, the polymer may be a silicone gum which is a polymer of high molecular weight with a very high viscosity. A gum will typically have a viscosity of at least 2000 000 mm²·s⁻¹ (cSt) at 25° C. but generally has a significantly greater viscosity. Hence, gums are often characterised by their Williams plasticity value in accordance with ASTM D-926-08 given the viscosity becomes very difficult to measure. Alternative to relying on Williams plasticity, gums can also be graded by their Shore A hardness measured by e.g. ASTM D2240-03, with values typically being at least 30.

Another way of modifying a TPE is by cross-linking the elastomeric component of a TPE during mixing to create a special form of TPE known in the art as a thermoplastic vulcanizate (TPV) in which the crosslinked elastomeric phase is insoluble and non-flowable at elevated temperature, TPVs generally exhibit improved oil and solvent resistance as well as reduced compression set relative to the simple blends. Typically, a TPV is formed by a process known as dynamic vulcanization, wherein the components required to make the elastomer (e.g. polymer, cross-linker and catalyst) and the thermoplastic matrix are mixed together and the elastomer is simultaneously cured to create a “co-continuous blend” of thermoplastic matrix and elastomer.

A number of such TPVs are known in the art, including some wherein the crosslinked elastomeric component can be a silicone polymer cured with the aid of a crosslinking agent and/or catalyst during the mixing process while the thermoplastic component is an organic, non-silicone polymer. Such TPVs are sometimes referred to as thermoplastic silicone vulcanizates or TPSiVs subsequent to their manufacture, TPVs e.g. TPSiVs may be processed by conventional techniques, such as extrusion, vacuum forming, injection moulding, blow moulding, 3D printing or compression moulding, to fabricate plastic parts.

However, the addition of many of these additives in various combinations to thermoplastic polymers, while improving tribological properties have reduced other desirable physical and mechanical properties. Some lubricants have proven satisfactory for short terms at low speeds and loads, however, desirable friction properties of many of these lubricants significantly deteriorate over long periods of time under increased loads.

It has now been identified that the use of thermoplastic silicone vulcanisates can provide a thermoplastic material with an enhanced resistance to stick-slip interactions leading to minimal or no audible noise and reduced wear and as such can be utilised to reduce the on-set of the stick-slip phenomenon.

There is provided herein a shaped article of a thermoplastic material comprising a blend of
(A) one or more thermoplastic organic materials, with
(B) a masterbatch of a stick-slip modifier comprising
   (B1) one or more thermoplastic organic materials,
   (B2) a silicone elastomer; and/or
   (B3) an uncured organopolysiloxane polymer
      in which masterbatch (B) there is contained from 20% to 60% by weight of cross-linked silicone elastomer based on the weight of (B1)+(B2)+(B3) and in which thermoplastic elastomer composition there is a total of from 0.2 to 25% by weight of cross-linked silicone elastomer based on the weight of (A)+(B). The thermoplastic material may be a thermoplastic elastomeric material.

There is also provided an assembly comprising: a shaped article in frictional contact with a sliding member, the shaped article and the sliding member being configured to remain in contact and move relative to each other, the shaped article comprising a thermoplastic material comprising a blend of
(A) one or more thermoplastic organic materials, with
(B) a masterbatch of a stick-slip modifier comprising
   (B1) one or more thermoplastic organic materials,
   (B2) a silicone elastomer; and/or
   (B3) an uncured organopolysiloxane polymer
      in which masterbatch (B) there is contained from 20% to 60% by weight of cross-linked silicone elastomer based on the weight of (B1)+(B2)+(B3) and in which thermoplastic elastomer composition there is a total of from 0.2 to 25% by weight of cross-linked silicone elastomer based on the weight of (A)+(B). The thermoplastic material may be a thermoplastic elastomeric material.

There is also provided a method for making a shaped article with the thermoplastic composition as hereinbefore described comprising making a masterbatch (B) comprising
(B1) one or more thermoplastic organic materials,
(B2) a silicone elastomer; and/or
(B3) an uncured organopolysiloxane polymer by
   (i) mixing components used to produce silicone elastomer (B2) to form a silicone composition,
   (ii) blending the silicone composition with one or more thermoplastic organic materials,
   (iii) when the silicone elastomer B2 is being made, dynamically vulcanising the silicone composition to form silicone elastomer (B2), and/or
   (iv) introducing (B3), which when B2 is present is, during step (ii) or after step (iii) ;
      in which masterbatch (B) there is contained from 20% to 60% by weight of cross-linked silicone elastomer based on the weight of (B1)+(B2)+(B3) and blending the resulting masterbatch with one or more thermoplastic organic materials (A) in an amount such that the thermoplastic elastomer composition a total of from 0.2 to 25% by weight of cross-linked silicone elastomer based on the weight of (A)+(B) and shaping the thermoplastic material to form a shaped article. The thermoplastic material may be a thermoplastic elastomeric material.

There is also provided herein the use of a thermoplastic silicone vulcanisate in a masterbatch to reduce the occurrence of stick-slip interactions by a thermoplastic material.

The utilisation of the masterbatches as hereinbefore described ensures a good dispersion and interaction within a thermoplastic material. Moreover, the use of a silicone rubber vulcanizate dispersion delivers compounds which will present excellent surface aspect and minimum if any silicone oil migration from the thermoplastic material with time. Furthermore, the need to use fluoropolymers is avoided. A further advantage of using masterbatches as hereinbefore described is ease of use allowing any compounder or injection moulder to use this solution. It enables increased flexibility on the amounts used and as such is more costs effective as it allows a direct modification of the thermoplastic, for example polycarbonate/acrylonitrile-butadiene-styrene (PC/ABS) materials used which differs from current options such as anti-squeaking coatings and chemically modified ready to use materials e.g. PC/ABS combinations.

The present disclosure is particularly directed to a polymer composition that can be used to make moulded parts such that when the parts slide against each other noise generation due to the effect of stick/slip is inhibited or even eliminated. Of particular advantage, compositions made according to the present disclosure can be used to create opposing sliding members that have reduced stick-slip characteristics which thus prevents the sliding members from generating noise during use.

Introducing a silicone vulcanized phase into a thermoplastic is able to combine the above benefits, thanks to the flexibility and high elasticity of the silicone once crosslinked, the low Tg of the polydimethylsiloxane, and the surface modification brought by the silicone domain at the surface. These benefits may even be observed at high Si content, the cros slinking of silicone in finite particles enabling the coalescence in larger size silicone domains.

For the avoidance of doubt, silanes and siloxanes are compounds containing silicon.
A silane is a compound derived from Si—H₄. A silane often contains at least one Si—C bond and unless otherwise indicated contains only one Si atom.
A polysiloxane contains several Si—O—Si-bonds forming a polymeric chain, where the backbone of the polymeric chain is made up of -(Si—O)-repeating units. An organopolysiloxane contains repeating -(Si—O—)-units where at least one Si atom bears at least one organic group. “Organic” means containing at least one carbon atom. An organic group is a chemical group comprising at least one carbon atom.

A polysiloxane comprises terminal groups and pendant groups. A terminal group is a chemical group located on a Si atom which is at an end of the polymer chain. A pendant group is a group located on a Si atom which Si atom is not at the end of the polymeric chain. Typically, an organopolysiloxane contains a mixture of the following structures:

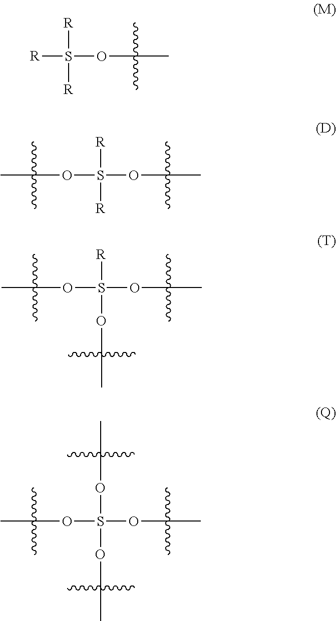

wherein each of M, D, T, and Q independently represent functionality of structural groups of organopolysiloxane. Specifically, M represents a monofunctional group R₃SiO_{1/2}; D represents a difunctional group R₂SiO_{2/2}; T represents a trifunctional group RSiO_{3/2}; and Q represents a tetrafunctional group SiO_{4/2}. Hence, for example linear organopolysiloxanes have a backbone of D units and the terminal groups are M units and branched organopolysiloxanes may, for example, have a backbone of D units interspersed with T and/or Q units.
A polymer is a compound containing repeating units which units typically form at least one polymeric chain. A polymer can be a homopolymer or a copolymer. A homopolymer is a polymer which is formed from only one type of monomer. A copolymer is a polymer formed from at least two different monomers. A polymer is called an organic polymer when the repeating units contain carbon atoms.

A cross linking reaction is a reaction where two or more molecules, at least one of them being a polymer, are joined together to harden or cure the polymer. A cross linker is a compound able to produce a crosslinking reaction of a polymer.

The one or more thermoplastic organic materials (B1) may be selected from polycarbonates (PC); blends of polycarbonates with other polymers as exemplified by polycarbonate/acrylonitrile-butadiene-styrene (PC/ABS) blends and polycarbonate-polybutylene terephthalate (PC/PBT) blends; polyamides exemplified by Nylons such as polycaprolactam (Nylon-6), polylauryllactam (Nylon-12), polyhexamethyleneadipamide (Nylon-6,6), and polyhexamethylenedodecanamide (Nylon-6,12), poly(hexamethylene sebacamide (Nylon 6,10), and blends of Nylons with other polymers; polyesters exemplified by polybutylene terephthalate (PBT), polyethylene terephthalate (PET), and polyethylene naphthalate (PEN); polyphenylene ether (PPE) and polyphenyleneoxide (PPO), and blends of PPE or PPO with styrenics such as high-impact polystyrene (HIPS), polystyrene, acrylonitrile-butadiene-styrene-(ABS) and styrene acrylonitrile resins (SAN); polyphenylene sulphide (PPS), polyether sulphone (PES), polyaramids, polyimides, phenyl-containing resins having a rigid rod structure, styrenic materials exemplified by ABS (acrylonitrile-butadiene-styrene), polystyrene (PS) and HIPS; polyacrylates, ; halogenated plastics exemplified by polyvinyl chloride, fluoroplastics, and any other halogenated plastics; polyketones, polymethylmethacrylate (PMMA), Polyolefins exemplified by polypropylene (PP), polyethylene (PE) including high density polyethylene (HDPE) and low density polyethylene (LDPE), polybutene (PB) as well as, copolymers and blends of polyolefin, thermoplastic elastomers such as thermoplastic urethanes, thermoplastic polyolefinic elastomers, thermoplastic vulcanizates;, and styrene ethylene butylene styrene (SEBS) copolymer, and natural products such as cellulosics, rayon, and polylactic acid. As previously indicated the one or more thermoplastic organic materials (B1) may be a mixture of more than one of the thermoplastic resins described above.

Component (B1) is present in an amount of from 40 to 80% by weight of the total weight of component B; alternatively 45% to 70% by weight of the total weight of component B.

Silicone elastomer (B2) may be prepared by curing one of the following compositions:

(B2a1) A diorganopolysiloxane having an average of at least two alkenyl groups per molecule and either
(i) an organopolysiloxane having at least two Si-bonded hydrogen atoms, alternatively at least three Si-bonded hydrogen atoms per molecule (B2a2) and a hydrosilylation catalyst (B2a3) and optionally a catalyst inhibitor (B2a5); or
(ii) a radical initiator (B2a4).

Alternatively Silicone elastomer (B2) may be prepared by curing a composition comprising
a silanol terminated diorganopolysiloxane (B2b1),
organopolysiloxane having at least two Si-bonded hydrogen atoms, alternatively at least three Si-bonded hydrogen atoms per molecule (B2a2) and and
a condensation catalyst (B2b3).

The silicone elastomer present in the masterbatch is present in an amount of from 20 to 60% by weight of the total weight of component (B); alternatively from 30 to 55% by weight of the total weight of component (B)

Diorganopolysiloxane having an Average of at Least Two Alkenyl Groups per Molecule (B2a1)

The diorganopolysiloxane polymer (B2a1) is a fluid or gum having a viscosity of at least 100 000 mm²·s⁻¹ (cSt) at 25° C., alternatively at least 1000000 mm²·s⁻¹ (cSt) at 25° C. The silicon-bonded organic groups of component (B2a1) are independently selected from hydrocarbon or halogenated hydrocarbon groups. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; alkenyl groups having 2 to 20 carbon atoms, such as vinyl, allyl and hexenyl; aryl groups having 6 to 12 carbon atoms, such as phenyl, tolyl and xylyl; aralkyl groups having 7 to 20 carbon atoms, such as benzyl and phenethyl; and halogenated alkyl groups having 1 to 20 carbon atoms, such as 3,3,3-trifluoropropyl and chloromethyl. It will be understood, of course, that these groups are selected such that the diorganopolysiloxane has a glass transition temperature (or melt point) which is below room temperature such that this component forms an elastomer when cured. Methyl preferably makes up at least 85, more preferably at least 90, mole percent of the silicon-bonded organic groups in component (B2a1).

Thus, polydiorganosiloxane (B2a1) can be a homopolymer, a copolymer or a terpolymer containing such organic groups. Examples include fluids or gums comprising dimethylsiloxy units, dimethylsiloxy units and phenylmethylsiloxy units; dimethylsiloxy units and diphenylsiloxy units; and dimethylsiloxy units, diphenylsiloxy units and phenylmethylsiloxy units, among others. The molecular structure is also not critical and is exemplified by straight-chain and partially branched straight-chain, linear structures of dimethylsiloxy units being preferred. Examples may include an α,ω-vinyldimethylsiloxy polydimethylsiloxane, α,ω-vinyldimethylsiloxy copolymer of methylvinylsiloxane and dimethylsiloxane units, and/or an α,ω-trimethylsiloxy copolymer of methylvinylsiloxane and dimethylsiloxane units.

The diorganopolysiloxane polymer (B2a1) may have a viscosity of at least 100 000 mm²·s⁻¹ (cSt) at 25° C., but typically of at least 1000000 mm²·s⁻¹ (cSt) at 25° C. which may be measured by using an AR 2000 Rheometer from TA Instruments of New Castle, Del., USA or a suitable Brookfield viscometer with the most appropriate spindle for the viscosity being measured. The diorganopolysiloxane polymer (B2a1) can if desired be a gum characterised by a Williams plasticity value of at least 100mm/100 as measured by ASTM D-926-08 using a Williams Parallel plate plastimeter given the viscosity values are so high they become very difficult to determine with accuracy. Alternative to relying on Williams plasticity gums can also be graded by their Shore A hardness measured by e.g. ASTM D2240-03, with values typically being at least 30. The diorganopolysiloxane polymer (B2a1) can, if desired, be modified with a small amount of an unreactive silicone such as a trimethylsilyl-terminated polydimethylsiloxane. In one alternative the diorganopolysiloxane polymer (B2a1) is a gum.

The alkenyl groups of the diorganopolysiloxane (B2a1) can be exemplified by vinyl, hexenyl, allyl, butenyl, pentenyl, and heptenyl groups. Silicon-bonded organic groups in diorganopolysiloxane polymer (B2a1) other than alkenyl groups may be exemplified by methyl, ethyl, propyl, butyl, pentyl, hexyl, or similar alkyl groups; or phenyl, tolyl, xylyl, or similar aryl groups.

Organopolysiloxane having at Least Two Si-Bonded Hydrogen Atoms, Alternatively at Least Three Si-Bonded Hydrogen Atoms Per Molecule (B2a2)

The Organopolysiloxane having at least two Si-bonded hydrogen atoms, alternatively at least three Si-bonded hydrogen atoms per molecule (B2a2) can, for example, be a low molecular weight organosilicon resin or a short or long chain organosiloxane polymer, which may be linear or cyclic. The silicon-bonded organic groups of component (B2a2) are independently selected from any of the hydrocarbon or halogenated hydrocarbon groups described above in connection with diorganopolysiloxane (B2a1 and B2b1), including preferred embodiments thereof. The molecular structure of component (B2a2) is also not critical and is exemplified by straight-chain, partially branched straight-chain, branched, cyclic and network structures, linear polymers or copolymers being preferred, and this component should be effective in curing component (B2a1) and (B2b1). (B2a2) preferably has at least 3 silicon-bonded hydrogens per molecule which are capable of reacting with the alkenyl or other aliphatically unsaturated groups of the diorganopolysiloxane polymer (B2a1) and the —OH groups of (B2b1) as will be discussed further below). The position of the silicon-bonded hydrogen in component (B2a2) is not critical, i.e. it the Si—H groups may be terminal groups or pendant groups in non-terminal positions along the molecular chain or at both positions. To ensure cross-linking when (B2a2) has only two Si—H bonds at least some of the respective polymer (B2a1) or (B2b1) needs to have at least 3 groups with which (B2a2) molecules can react. The organopolysiloxane having at least two Si-bonded hydrogen atoms, alternatively at least three Si-bonded hydrogen atoms per molecule (B2a2) may, for example, have the general formula

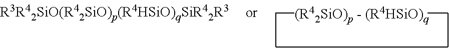

wherein R⁴ denotes an alkyl or aryl group having up to 10 carbon atoms, and R³ denotes a group R⁴ or a hydrogen atom, p has a value of from 0 to 20, and q has a value of from 1 to 70, and there are at least 2 or 3 silicon-bonded hydrogen atoms present per molecule. R4 can, for example, be a lower alkyl group having 1 to 3 carbon atoms, such as a methyl group. The Organopolysiloxane having at least two Si-bonded hydrogen atoms, alternatively at least three Si-bonded hydrogen atoms per molecule (B2a2) can, for example, have a viscosity of from 0.5 to 1000 mm².s⁻¹ (cSt) at 25° C., alternatively 2 to 100 mm²·s⁻¹ (cSt) or 5 to 60 mm².s⁻¹ (cSt) at 25° C., typically measured using a Brookfield viscometer and the most appropriate spindle for the viscosity range being measured. The average degree of polymerisation of (B2a2) can, for example, be in the range 30 to 400 siloxane units per molecule.

Component (B2a2) may be exemplified by the following siloxanes typically having a viscosity of from 0.5 to 1000 mm²·s⁻¹ (cSt) at 25° C. low molecular siloxanes, such as PhSi(OSiMe₂ H)₃;
trimethylsiloxy-endblocked methylhydridopolysiloxanes;
trimethylsiloxy-endblocked dimethylsiloxane-methylhydridosiloxane copolymers;
dimethylhydridosiloxy-endblocked dimethylpolysiloxanes;
dimethylhydrogensiloxy-endblocked methylhydrogenpolysiloxanes; dimethylhydridosiloxy-endblocked dimethylsiloxane-methylhydridosiloxane copolymers;
cyclic methylhydrogenpolysiloxanes;
cyclic dimethylsiloxane-methylhydridosiloxane copolymers;
tetrakis (dimethylhydrogensiloxy)silane;
silicone resins composed of (CH₃)₂ HSiO_{1/2}, (CH₃)₃ SiO_{1/2}, and SiO_{4/2} units; and
silicone resins composed of (CH₃)₂ HSiO_{1/2}, (CH₃)₃ SiO_{1/2}, CH₃ SiO_{1/2}, PhSiO_{3/2} and SiO_{4/2} units
(B2a2) may comprise a mixture of more than one of these materials.

The molar ratio of Si—H groups in (B2a2) to aliphatically unsaturated groups in the diorganopolysiloxane polymer (B2a1) is preferably at least 1:1 and can be up to 8:1 or 10:1. For example the molar ratio of Si—H groups to aliphatically unsaturated groups is in the range from 1.5:1 to 5:1.

(B2a2) is used at a level such that the molar ratio of Si—H therein to Si—OH in component (B2b1) is about 0.5 to 10, preferably 1 to 5 and most preferably about 1.5.

These Si—H-functional materials are well known in the art and many of them are commercially available

Hydrosilylation Catalyst (B2a3)

The hydrosilylation catalyst (B2a3) is preferably a platinum group metal (platinum, ruthenium, osmium, rhodium, iridium and palladium) or a compound thereof. Platinum and/or platinum compounds are preferred, for example finely powdered platinum; a chloroplatinic acid or an alcohol solution of a chloroplatinic acid; an olefin complex of a chloroplatinic acid; a complex of a chloroplatinic acid and an alkenylsiloxane; a platinum-diketone complex; metallic platinum on silica, alumina, carbon or a similar carrier; or a thermoplastic resin powder that contains a platinum compound. Catalysts based on other platinum group metals can be exemplified by rhodium, ruthenium, iridium, or palladium compounds. For example, these catalysts can be represented by the following formulas: RhCl(PPh₃)₃, RhCl(CO)(PPh₃)₂, Ru₃(CO)₁₂, IrCl(CO)(PPh₃)₂, and Pd(PPh₃)₄ (where Ph stands for a phenyl group).

The catalyst (B2a3) is preferably used in an amount of 0.5 to 100 parts per million by weight platinum group metal based on the polyorganosiloxane composition (B), more preferably 1 to 50 parts per million. The hydrosilylation catalyst (B2a3) catalyses the reaction of the alkenyl groups of diorganopolysiloxane polymer (B2a1) with the Si—H groups of (B2a2).

### Inhibitor (B2a5)

Optionally, when a hydrosilylation catalyst is being utilised to cure diorganopolysiloxane polymer (B2a1) an inhibitor (B2a5) may be included in the composition to retard the cure process. By the term “inhibitor” it is meant herein a material that retards curing of Components (B2a1) when incorporated therein in small amounts, such as less than 10 percent by weight of the silicone composition of (B2a1) without preventing the overall curing of the mixture.

Inhibitors of platinum group based catalysts (B2a5), especially platinum based catalysts (B2a5) are well known. They include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

The inhibitors (B2a5) used herein, when present, may be selected from the group consisting of acetylenic alcohols and their derivatives, containing at least one unsaturated bond. Examples of acetylenic alcohols and their derivatives include 1-ethynyl-1-cyclohexanol (ETCH), 2-methyl-3-butyn-2-ol, 3-butyn-l-ol, 3-butyn-2-ol, propargylalcohol, 2-phenyl-2-propyn-l-ol, 3,5-dimethyl-l-hexyn-3-ol, 1-ethynylcyclopentanol, 1-phenyl-2-propynol, 3-methyl-l-penten-4-yn-3-ol, and mixtures thereof.

Alternatively, the inhibitor (B2a5) is selected from the group consisting of 1-ethynyl-1-cyclohexanol, 2-methyl-3-butyn-2-ol, 3-butyn-l-ol, 3-butyn-2-ol, propargylalcohol, 2-phenyl-2-propyn-l-ol, 3,5-dimethyl-l-hexyn-3-ol, 1-ethynylcyclopentanol, 1-phenyl-2-propynol, and mixtures thereof.

The inhibitor (B2a5) may typically be a acetylenic alcohols where the at least one unsaturated bond (alkenyl group) is in a terminal position, and further, a methyl or phenyl group may be at the alpha position. The inhibitor may be selected from the group consisting of 1-ethynyl-1-cyclohexanol, 2-methyl-3-butyn-2-ol, 3-butyn-l-ol, 3-butyn-2-ol, propargylalcohol, 2-phenyl-2-propyn-1-ol, 1-phenyl-2-propynol, and mixtures thereof.

The inhibitor (B2a5) may be added in the range of from 0 to 10% by weight of component (B), alternatively 0.05 to 5% by weight of component (B2), but is generally used in an amount sufficient to retard cure of diorganopolysiloxane gum (B2a1) which may be optimized for a given system by those skilled in the art using routine experimentation.

### Radical Initiator (B2a4)

Radical initiator (B2a4) is a compound which decomposes at elevated temperature to form radical species. The latter promotes the crosslinking reaction between the alkenyl groups of diorganopolysiloxane gum (B2a1) during the dynamic vulcanization step of the instant method. This component may be illustrated by known azo compounds, carbon compounds and organic peroxy compounds, such as hydroperoxides, diacyl peroxides, ketone peroxides, peroxyesters, dialkyl peroxides, diaryl peroxides, aryl-alkyl peroxides, peroxydicarbonates, peroxyketals, peroxy acids, acyl alkylsulfonyl peroxides and alkyl monoperoxydicarbonates.

For the purposes of the present invention, radical initiator (B2a4) is selected such that the difference between the six-minute half-life temperature of the initiator and the process temperature is between −60° C. and 20° C. That is, the following condition is satisfied: −60° C. ≤{T(6)−T(O)}≤20° C., wherein T(6) represents the temperature (° C.) at which the initiator has a half-life of 6 minutes and T(O) represents the processing temperature (° C.) prior to initiator addition (i.e., the actual temperature of the mixture of components (B1) through (B3)). The value of T(6) is available from the manufacturer of the initiator or can be determined by methods known in the art. After the initiator is introduced, the temperature generally increases slightly as dynamic vulcanization takes place unless intentional cooling is applied. However, such cooling is not generally required unless temperature increases dramatically (e.g., more than about 30° C.).

Specific non-limiting examples of suitable radical initiators include 2,2′-azobisisobutyronitrile, 2,2′-azobis(2-methylbutyronitrile), dibenzoyl peroxide, tert-amyl peroxyacetate, 1,4-di(2-tert-butylperoxyisopropyl)benzene, tert-butyl cumyl peroxide, 2,4,4-trimethylpentyl-2 hydroperoxide, diisopropylbenzene monohydroperoxide, cumyl hydroperoxide, tert-butyl hydroperoxide, tert-amyl hydroperoxide, 1,1-di(tert-butylperoxy)cyclohexane, tert-butylperoxy isopropyl carbonate, tert-amyl peroxybenzoate, dicumyl peroxide, 2,5-dimethyl-2,5-di-(tert-butylperoxy)hexane bis(1-methyl-1-phenylethyl)peroxide, 2,5-dimethyl-2,5-di-(tert-butylperoxy)hexyne-3, di-tert-butyl peroxide, α,α-dimethylbenzyl hydroperoxide and 3,4-dimethyl-3,4-diphenylhexane.

Initiator (B2a4) is used in an amount sufficient to cure diorganopolysiloxane gum (B2a1) and this amount can be optimized for a given system by those skilled in the art using routine experimentation. When the amount is too low, insufficient crosslinking takes place and mechanical properties will be poor. It is readily determined by a few simple experiments for the system under consideration. On the other hand, when excess initiator is added, it is uneconomical and undesirable side reactions, such as polymer degradation, tend to occur. Initiator (B2a4) is preferably added at a level of 0.05 to 6 parts by weight, alternatively 0.2 to 3 parts by weight, for each 100 parts by weight of diorganopolysiloxane (B2a1).

### Diorganopolysiloxane (B2b1)

Diorganopolysiloxane (B2b1) is a fluid or gum terminated with silanol (i.e., —Si—OH) groups having a viscosity of at least 100 000 mm²·s⁻¹ (cSt) at 25° C. alternatively at least 1000000 mm²·s⁻¹ (cSt) at 25° C. The silicon-bonded organic groups of component (B2b1) are independently selected from hydrocarbon or halogenated hydrocarbon groups as defined for (B2a1) above. Again, methyl preferably makes up at least 85, more preferably at least 90, mole percent of the silicon-bonded organic groups in component (B2b1).

Thus, polydiorganosiloxane (B2b1) can be a homopolymer, a copolymer or a terpolymer containing such organic groups. Examples include fluids or gums comprising dimethylsiloxy units and phenylmethylsiloxy units; dimethylsiloxy units and diphenylsiloxy units; and dimethylsiloxy units, diphenylsiloxy units and phenylmethylsiloxy units, among others. The molecular structure is also not critical and is exemplified by straight-chain and partially branched straight-chain, linear structures being preferred.

Specific illustrations of organopolysiloxane (B2b1) include: dimethylhydroxysiloxy-end-blocked dimethylsiloxane homopolymers; dimethylhydroxysiloxy end-blocked methylphenylsiloxane-dimethylsiloxane copolymers; and dimethylhydroxysiloxy-endblocked methylphenylpolysiloxanes. Preferred systems for low temperature applications include silanol-functional methylphenylsiloxane-dimethylsiloxane copolymers and diphenylsiloxane-dimethylsiloxane copolymers, particularly wherein the molar content of the dimethylsiloxane units is about 93%.

Component (B2b1) may also consist of combinations of two or more organopolysiloxane fluids or gums. Most preferably, component (B2b1) is a polydimethylsiloxane homopolymer which is terminated with a silanol group at each end of the molecule.

Preferably, the molecular weight of the diorganopolysiloxane is sufficient to impart a Williams plasticity number of at least about 30 as determined by ASTM D-926-08. The plasticity number, as used herein, is defined as the thickness in millimeters×100 of a cylindrical test specimen 2 cm³ in volume and approximately 10 mm in height after the specimen has been subjected to a compressive load of 49 Newtons for three minutes at 25° C. Although there is no absolute upper limit on the plasticity of component (B2b1), practical considerations of processability in conventional mixing equipment generally restrict this value. Preferably, the plasticity number should be about 100 to 200, most preferably about 120 to 185. We have found that such gums can readily be dispersed in the one or more thermoplastic organic materials (B1) without the need for filler (B2c).

It has, however, been found that fluid diorganopolysiloxanes having a viscosity of about 10 to 100 Pa-s at 25° C. often cannot be readily dispersed in athermoplastic resin (A). Under these circumstances, the fluid must be mixed with up to about 300 parts by weight of filler (B2c), described infra, for each 100 parts by weight of (B2b1) in order to facilitate dispersion. Preferably, the fluid and filler are mixed before adding this combination to resin (A), but these can be added separately.

### Condensation Catalyst (B2b3)

n general, the condensation catalyst (B2b3) of the present invention is any compound which will promote the condensation reaction between the Si—OH groups of diorganopolysiloxane (B2b1) and the Si—H groups of the Organopolysiloxane having at least two Si-bonded hydrogen atoms, alternatively at least three Si-bonded hydrogen atoms per molecule (B2a2)_so as to cure the former by the formation of —Si—O—Si-bonds. However, as noted above, catalyst (B2b3) cannot be a platinum compound or complex since the use of such a condensation catalyst often results in poor processing as well as poor physical properties of the resulting TPSiV.

The condensation catalyst (B2b3) is present in an amount sufficient to cure diorganopolysiloxane (B2b1) and the Organopolysiloxane having at least two Si-bonded hydrogen atoms, alternatively at least three Si-bonded hydrogen atoms per molecule (B2a2) (B2a2) as defined above.

Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide (see, e.g., U.S. Pat. No. 3,024,210).

### Optional Reinforcing Filler (B2c).

Optionally the composition used to make the silicone elastomer may contain a reinforcing filler (B2c). The reinforcing filler (B2c) can, for example, be silica. The silica can, for example, be fumed (pyrogenic) silica, such as that sold by Cabot under the trade mark Cab-O-Sil MS-75D, or can be precipitated silica. The particle size of the silica is for example in the range 0.5 μm to 20 μm, alternatively 1 μm to 10 μm. The silica can be treated silica produced for example by treating silica with a silane or with a polysiloxane. The silane or polysiloxane used to treat the silica usually contains hydrophilic groups which bond to the silica surface and aliphatically unsaturated hydrocarbon or hydrocarbonoxy groups and/or Si-bonded hydrogen atoms.

The silica can, for example, be treated with an alkoxysilane, for example a silane comprising at least one Si-bonded alkoxy group and at least one Si-bonded alkenyl group or at least one Si-bonded hydrogen atom. The alkoxysilane can be a monoalkoxysilane, a dialkoxysilane or a trialkoxysilane containing at least one aliphatically unsaturated hydrocarbon group such as a vinylalkoxysilane, for example vinyltrimethoxysilane, vinyltriethoxysilane or vinymethyldimethoxysilane. The Si-bonded alkoxy groups are readily hydrolysable to silanol groups which bond to the silica surface.

The silica can alternatively be treated with a polysiloxane, for example an oligomeric organopolysiloxane, containing Si-bonded alkenyl groups and silanol end groups.

The silica can, for example, be treated with 2% to 60% by weight based on the silica of an alkoxysilane containing alkenyl groups or an oligomeric organopolysiloxane containing alkenyl groups.

### Thermoplastic Organic Material (A)

The masterbatch as described above once prepared is introduced into the thermoplastic material (A). Similar to the thermoplastic material (B1), the thermoplastic material (A) may be chosen from may be selected from polycarbonates (PC), blends of polycarbonates with other polymers as exemplified by polycarbonate-acrylonitrile-butadiene-styrene (PC/ABS) blends and polycarbonate-polybutylene terephthalate (PC/PBT) blends; polyamides exemplified by Nylons such as polycaprolactam (Nylon-6), polylauryllactam (Nylon-12), polyhexamethyleneadipamide (Nylon-6,6), and polyhexamethylenedodecanamide (Nylon-6,12), poly(hexamethylene sebacamide (Nylon 6,10), and blends of Nylons with other polymers; polyesters exemplified by polybutylene terephthalate (PBT), polyethylene terephthalate (PET), and polyethylene naphthalate (PEN); polyphenylene ether (PPE) and polyphenyleneoxide (PPO), and blends of PPE or PPO with styrenics such as high-impact polystyrene (HIPS), polystyrene, acrylonitrile-butadiene-styrene-(ABS) and styrene acrylonitrile resins (SAN); polyphenylene sulphide (PPS), polyether sulphone (PES), polyaramids, polyimides, phenyl-containing resins having a rigid rod structure, styrenic materials exemplified by ABS (acrylonitrile-butadiene-styrene), polystyrene (PS) and HIPS; polyacrylates; halogenated plastics exemplified by polyvinyl chloride, fluoroplastics, and any other halogenated plastics; polyketones, polymethylmethacrylate (PMMA), Polyolefins exemplified by polypropylene (PP), polyethylene (PE) including high density polyethylene (HDPE) and low density polyethylene (LDPE), polybutene (PB) as well as copolymers and blends of polyolefin, thermoplastic elastomers such as thermoplastic urethanes, thermoplastic polyolefinic elastomers, thermoplastic vulcanizates; and styrene ethylene butylene styrene (SEBS) copolymer, and natural products such as cellulosics, rayon, and polylactic acid. As previously indicated the one or more thermoplastic organic materials (B1) may be a mixture of more than one of the thermoplastic resins described above.

### Linear Organopolysiloxane (B3)

Linear organopolysiloxane (B3) may be a fluid or gum having a viscosity of at least 10 000 mm²·s⁻¹ (cSt) at 25° C., alternatively at least 50 000 mm²·s⁻¹ (cSt) at 25° C. alternatively at least 500 000 mm²·s⁻¹ (cSt) at 25° C. alternatively a viscosity of 600,000 mm²·S⁻¹ (cSt) or greater, typically measured using a Brookfield viscometer and the most appropriate spindle for the viscosity range being measured. The silicon-bonded organic groups of component (B3) are independently selected from hydrocarbon or halogenated hydrocarbon groups. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; alkenyl groups having 2 to 20 carbon atoms, such as vinyl, allyl and hexenyl; aryl groups having 6 to 12 carbon atoms, such as phenyl, tolyl and xylyl; aralkyl groups having 7 to 20 carbon atoms, such as benzyl and phenethyl; and halogenated alkyl groups having 1 to 20 carbon atoms, such as 3,3,3-trifluoropropyl and chloromethyl. It will be understood, of course, that these groups are selected such that the diorganopolysiloxane has a glass transition temperature (or melt point) which is below room temperature such that this component forms an elastomer when cured. At least 85, more preferably at least 90, mole percent of the silicon-bonded organic groups in component (B3) are methyl and/or ethyl groups, alternatively methyl groups.

Thus, polydiorganosiloxane (B3) can be a homopolymer, a copolymer or a terpolymer containing such organic groups. Examples include fluids or gums comprising dimethylsiloxy units and phenylmethylsiloxy units; dimethylsiloxy units and diphenylsiloxy units; and dimethylsiloxy units, diphenylsiloxy units and phenylmethylsiloxy units, among others. The molecular structure is also not critical and is exemplified by straight-chain and partially branched straight-chain, linear structures being preferred.

### Stabilizer (C)

The composition herein may also comprise a stabilizer (C). Stabiliser (C) may be an antioxidant, for example a hindered phenol antioxidant such as tetrakis(methylene(3,5-di-tert-butyl-4-hydroxy-hydrocinnamate)methane sold by BASF under the trade mark ‘Irganox® 1010’. Such an antioxidant can, for example, be used at 0.05 to 0.5% by weight of the thermoplastic composition.

Other optional Additives (Component (D))

Other optional Additives (Component (D)) may be added into the thermoplastic compositions hereinbefore described to obtain a desired processing or performance property, and or to enhance compatibility between the silicone phase (B) and the thermoplastic matrix (A). These additives may be added into the composition in for example a silicone base if required to be present within the silicone elastomer or alternatively can be added directly into the thermoplastic matrix if the intention is for the additives to be within the thermoplastic matrix.

Such additional components may, for example, include softening mineral oils, plasticisers, other mineral fillers (i.e. excluding the (B2c) reinforcing fillers), viscosity modifiers, lubricants, coupling agent, thermoplastic elastomer and fire resistant additives, coloring agents such as pigments and/or dyes; effect pigments, such as diffractive pigments; interference pigments, such as pearlescent agents; reflective pigments and mixtures thereof and mixtures of any of the above pigments; UV stabilizers, fluidizing agents, anti-abrasion agents, mold-release agents , plasticizers, impact modifiers, surfactants, brighteners, fillers, fibers, waxes, and mixtures thereof, and/or any other additive well known in the field of polymers not described in (C).

Mineral oils are generally petroleum distillates in the C₁₅ to C₄₀ range, for example white oil, liquid paraffin or a naphthenic oil. If used, the mineral oil can, for example, be premixed with the thermoplastic organic polymer (A). The mineral oil can, for example, be present in an amount of from 0.5 to 20% by weight based on the thermoplastic organic polymer (A). Plasticizers can be present in combination with or alternatively to mineral oils. Examples of suitable plasticisers include phosphate ester plasticisers such as triaryl phosphate isopropylated, resorcinal bis-(diphenyl phosphate) or phosphate ester sold by Great Lakes Chemical Corporation under the trade mark Reofos® RDP. Such plasticizers can, for example, be used in a range from 0.5 up to 15% by weight of the composition.

Coupling agents are selected from glycidyl ester functional polymers, organofunctional grafted polymers, an organofunctional modified organopolysiloxane, polymer composition comprising a thermoplastic polymer selected from a polar and a non-polar polymer and a branched block copolymer of a polysiloxane and a polymer, or mixtures thereof.

Examples of other mineral fillers include talc or calcium carbonate. Fillers may be treated to make their surface hydrophobic. Such fillers, if present, are preferably present at a lower level than the reinforcing filler (B2c) such as silica. Said fillers may be premixed either with the thermoplastic organic polymer (A) or the silicone base (B).

Examples of pigments include carbon black and titanium dioxide. Pigments can, for example, be premixed with the thermoplastic organic polymer (A). A lubricant can, for example, be a surface lubricating additive to improve the processability of the thermoplastic material in moulding operations. An example of a surface lubricating additive is Ethylbutylstearamide sold by CRODA under the trade mark ‘Crodamide-EBS’. A lubricant can, for example, be present in an amount of from 0.1 to 2% by weight of the thermoplastic elastomer composition.

Also contemplated within the scope of this invention is the use of fire retardant additives to provide fire retardancy to the compositions of this invention. Traditional fire retardants can be used herein and can be selected from the group consisting of halogenated varieties such as polydibromostyrene, copolymers of dibromostyrene, polybromostyrene, brominated polystyrene, tetrabromophthalate esters, tetrabromophthalate diol, tetrabromophthalate anhydride, tetrabromobenzoate ester, hexabromocyclododecane, tetrabromobisphenol A, tetrabromobisphenol A bis(2,3-dibromopropyl ether), tetrabromobisphenol A bis(allyl ether), phenoxy-terminated carbonate oligomer of tetrabromobisphenol A, decabromodiphenylethane, decabromodiphenyl oxide, bis-(tribromophenoxyl)ethane, ethane-1,2-bis(pentabromophenyl), tetradecabromodiphenoxybenzene, ethylenebistetrabromophthalimide, ammonium bromide, poly pentabromobenzyl acrylate, brominated epoxy polymer, brominated epoxy oligomer, and brominated epoxies. Other, non-halogen varieties can be selected from such materials as triaryl phosphates isopropylated, cresyl diphenyl phosphate, tricresyl phosphate, trixylxl phosphate, triphenylphosphate, triaryl phosphates butylated, resorcinol bis-(diphenyl phosphate), bisphenol A bis(diphenyl phosphate), melamine phosphate, melamine pyrophosphate, melamine polyphosphate, dimelamine phosphate, melamine, melamine cyanurate, magnesium hydroxide, antimony trioxide, red phosphorous, zinc borate, and zinc stanate.

A single optional additive or multiple optional additives (Component (D)) may be used in the thermoplastic masterbatch composition. The total proportion of the one or more additives of component (D) present should not exceed 30 weight % of the total weight of the thermoplastic masterbatch composition. Preferably if there is one or more components (D) present the total cumulative amount of said additives is typically present from 0.01 to 20%, preferably from 0.01 to 10%, preferably from 0.01 to 5%, by weight out of the total weight of the masterbatch composition B.

There is also provided a method for making a shaped article with the thermoplastic elastomer composition as hereinbefore described comprises making a masterbatch (B) comprising
(B1) one or more thermoplastic organic materials,
(B2) a silicone elastomer; and/or
(B3) an uncured organopolysiloxane polymer by
   (i) mixing components used to produce silicone elastomer (B2) to form a silicone composition,
   (ii) blending the silicone composition with one or more thermoplastic organic materials,
   (iii) when the silicone elastomer B2 is being made, dynamically vulcanising the silicone composition to form silicone elastomer (B2), and/or
   (iv) introducing (B3), which when B2 is present is, during step (ii) or after step (iii) ;
      in which masterbatch (B) there is contained from 20% to 60% by weight of cross-linked silicone elastomer based on the weight of (B1)+(B2)+(B3) and blending the resulting masterbatch with one or more thermoplastic organic materials (A) in an amount such that the thermoplastic composition contains a total of from 0.2 to 25% by weight of cross-linked silicone elastomer based on the weight of (A)+(B) and shaping the thermoplastic material to form a shaped article. The thermoplastic material may be a thermoplastic elastomeric material.

In an alternative embodiment a method of making a thermoplastic material, which may be a thermoplastic elastomeric material by making a masterbatch (B) as hereinbefore described and blending the resulting masterbatch with one or more thermoplastic organic materials (A) in an amount such that the thermoplastic material comprises a total of from 0.2 to 25% by weight of cross-linked silicone elastomer based on the weight of (A)+(B). In one alternative the masterbatch is introduced into component (A) in a pelletised form. In another alternative both component (A) and component (B) are dry blended together in a pelletised form.

Several alternatives may be used for the processes described above.

The plastics processing operations and equipment for blending components B1, B2 and optional B3 as well as the blending of components (A) and (B) for making the thermoplastic material utilising the need to soften the thermoplastic resins (A) and (B1) upon heat and allowing contact and uniform mixing of the ingredients may be carried out at temperatures within the range of from 60° C. up to 400° C. according to the softening or melting temperatures of the thermoplastic resin. Convenience equipment for any such process may be exemplified by but is not restricted to extrusion compounding operations utilising a uniaxial extruder, a biaxial extruder, or a multiaxial extruder. Alternatively blending can be undertaken using for example a batch internal mixer, such as a Z-blades mixer, or a Banbury mixer providing sufficient mixing time is allowed to ensure uniform distribution of the components.

Hereafter are provided a selection of alternative processes which may be utilised to make the masterbatch and thermoplastics elastomer composition as herein before described.

The masterbatch may be prepared using the following process in which successive insertion steps may be in the order provided but alternatively steps may be in an alternative order and in some instances some of the steps may be combined where appropriate depending on the processing equipment layout and the raw material compositions.
1. The one or more thermoplastic organic materials (B1) are first softened or melted at a temperature of from 60° C. up to 400° C. as required.
2. The components of (B2) involved in the dynamic vulcanization of the diorganopolysiloxane gum (B2a1) or (B2b1), to form the silicone elastomer portion of the masterbatch composition, are then introduced into the one or more thermoplastic organic materials (B1) at the elevated temperature.

Silicone elastomer (B2) is then prepared by dynamically curing one of the following cure compositions, optionally additionally containing one or more of (B2c), (B3), (C) and/or (D):
1) (B2a1) A diorganopolysiloxane having an average of at least two alkenyl groups per molecule and
   an organopolysiloxane having at least two Si-bonded hydrogen atoms,
   alternatively at least three Si-bonded hydrogen atoms per molecule (B2a2) and a hydrosilylation catalyst (B2a3) and optionally a catalyst inhibitor (B2a5);
2) (B2a1) A diorganopolysiloxane having an average of at least two alkenyl groups per molecule and a radical initiator (B2a4) and optionally organopolysiloxane having at least two Si-bonded hydrogen atoms, alternatively at least three Si-bonded hydrogen atoms per molecule (B2a2); or
3) a silanol terminated diorganopolysiloxane (B2b1),
an organopolysiloxane having at least two Si-bonded hydrogen atoms, which contain an average of at least two silicon bonded hydrogen group (B2b2) and a condensation catalyst (B2b3).

The diorganopolysiloxane gum (B2a1) or (B2b1) is introduced and distributed under mechanical mixing energy into the softened or melted matrix of the one or more thermoplastic organic materials (B1).

The ingredients of the alternative cure packages are then introduced separately (no preferable order) or in combination distributed in the mixture to initiate and complete the vulcanization of the respective gum. As previously discussed a hydrosilylation (addition cure) reaction inhibitor (B2a5) may be optionally inserted in the mixture to increase the residence time before the completion of vulcanization reaction in the case of a hydrosilylation (addition) cure process. When utilised the inhibitor (B2a5) is introduced into the composition either before catalyst and/or cross-linker.

The optional additives (B2c), (B3), (C) and/or (D): may be introduced at the same time or separately during or after the dynamic cure process has completed, as required. A reinforcing filler for the diorganopolysiloxane (B2c) can be inserted separately. For example the stabilizer additives (C) and additional components (D) can either be pre-blended in the one or more thermoplastic organic materials (B1) in a solid form prior to (B1) being exposed to elevated temperature or added in the melted one or more thermoplastic organic materials (B1) during the mixing operations.

Alternatively, rather than introducing each ingredient individually as described above pre-dispersed organopolysiloxane compositions may be introduced into the one or more thermoplastic organic materials (B1) at elevated temperature. The pre-dispersed organopolysiloxane compositions may comprise a single mixture of all the ingredients used to make the silicone elastomer or may utilise the introduction of a 2 or more mixtures which when mixed together complete the ingredients required to dynamically vulcanise (B2a1) or (B2b1) to form the silicone elastomer. The use of a pre-dispersed organopolysiloxane compound can complement or replace the individual ingredient insertion.

The pre-dispersed organosiloxane composition may comprise a diorganopolysiloxane with reactive groups or a blend of diorganopolysiloxane with reactive groups i.e. (B2a1) or (B2b1) either containing a reinforcing filler (B2c) or a cross-linker e.g. (B2a2) or (B2b2) or a combination of a reinforcing filler (B2c) and one of the cross-linker e.g. (B2a2) or (B2b2). The components of the pre-dispersed organosiloxane compound composition are blended together before introduction into the one or more thermoplastic organic materials (B1). The other ingredients may then be introduced independently.

Alternatively, there may be two pre-dispersed compositions (i.e. a two part composition) mixed together in the heated one or more thermoplastic organic materials (B1):
1. The first part containing organopolysiloxane (B2a1 or B2b1) and a hydrosilylation catalyst (B2a3) or a condensation catalyst (B2b3);
2. The second part containing organopolysiloxane (B2a1) or (B2b1), an organopolysiloxane having at least two Si-bonded hydrogen atoms, alternatively at least three Si-bonded hydrogen atoms per molecule (B2a2) and optionally a reaction inhibitor (B2a5).

In a further alternative one or more of the ingredients for making the silicone elastomer may be introduced into the one or more thermoplastic organic materials (B1) in the form of a pre-prepared masterbatch or liquid concentrate. For example, the appropriate cross-linker may be introduced into the composition for blending in a masterbatch with a thermoplastic material, e.g. the same material as a linear organopolysiloxane concentrate or siloxane masterbatch. Similarly when present siloxane (B3) may be introduced in the form of a masterbatch prepared upstream through a separate mixing operation.

In a still further alternative the components of the composition used to make the silicone elastomer may be pre-mixed and cured such that the cured silicone elastomer is blended into the one or more thermoplastic organic materials (B1) thereby avoiding the need for dynamic vulcanisation in the one or more thermoplastic organic materials (B1).

The silicone elastomer concentrate can be inserted in the final composition at elevated temperature, in the melted one or more thermoplastic organic materials (B1), or pre-blended with the one or more thermoplastic organic materials (B1) in its solid form prior the blend is inserted into the processing equipment and exposed to elevated temperature.

In a still further alternative, a masterbatch of (B3) (when required) and a masterbatch or masterbatches of the ingredients to make the silicone elastomer (B2) may all be pre-prepared and introduced into the one or more thermoplastic organic materials (B1) at elevated temperature and suitably mixed together.

One example of suitable melt blending equipment is a twin screw extruder. A twin screw extruder having a length/diameter (L/D) ratio over 40 may be particularly suitable. The thermoplastic organic polymer (A) can, for example, be introduced into the main feed of a co-rotative twin screw extruder operating at a temperature high enough to melt the thermoplastic organic polymer. The organopolysiloxane (B) can be added into the already melted thermoplastic organic polymer phase using for example a gear pump. The residence time of the liquid phase reagents in the extruder can, for example, be 30 to 240 seconds, optionally 50 to 150 seconds.

The assembly as hereinbefore described comprises: a shaped article in frictional contact with a sliding member, the shaped article and the sliding member being configured to remain in contact and move relative to each other, the shaped article comprising a thermoplastic material comprising a blend of
(A) one or more thermoplastic organic materials, with
(B) a masterbatch of a stick-slip modifier comprising
   (B1) one or more thermoplastic organic materials,
   (B2) a silicone elastomer; and/or
   (B3) an uncured organopolysiloxane polymer
      in which masterbatch (B) there is contained from 20% to 60% by weight of cross-linked silicone elastomer based on the weight of (B1)+(B2)+(B3) and in which thermoplastic elastomer composition there is a total of from 0.05 to 25% by weight of cross-linked silicone elastomer based on the weight of (A)+(B). The thermoplastic material may be a thermoplastic elastomeric material.

In one embodiment both the shaped article and the sliding member are made from a thermoplastic material, for example, a thermoplastic elastomeric material, comprising a blend of
(A) one or more thermoplastic organic materials, with
(B) a masterbatch of a stick-slip modifier comprising
   (B1) one or more thermoplastic organic materials,
   (B2) a silicone elastomer; and/or
   (B3) an uncured organopolysiloxane polymer
      in which masterbatch (B) there is contained from 20% to 60% by weight of cross-linked silicone elastomer based on the weight of (B1)+(B2)+(B3) and in which thermoplastic material there is a total of from 0.05 to 25% by weight of cross-linked silicone elastomer based on the weight of (A)+(B).

The shaped article as hereinbefore may be any article which, in use, is designed to move relative to and in frictional contact with a second object, herein referred to as a sliding member, whilst remaining in frictional contact with said sliding member. Typically the shaped article and the sliding member move relative to and in frictional contact with each other but it is to be understood that one of them may be stationary while the other is moving or both may be moving simultaneously but in each case they are sliding against each other when functional (i.e. in frictional contact) and therefore need to overcome relative kinetic friction and may be subject to the stick-slip phenomenon. Hence the shaped article may be, for the sake of example, an automobile part such as a housing, latch, window winding system, wiper part, sun roof part, lever, bush, gear, gear box part, pivot housing, bracket, zipper, switch, cam, sliding element or plate, in each case made of a thermoplastic composition or thermoplastic elastomer composition. The sliding member may also be any of the above or a housing therefor providing the shaped article and sliding member remain in frictional contact during use and move relative to each other during use. The sliding member may also be an automobile part such as a housing, latch, window winding system, wiper part, sun roof part, lever, bush, gear, gear box part, pivot housing, bracket, zipper, switch, cam, sliding element or plate in frictional contact therewith. The shaped article and sliding member may be parts, in frictional contact, of for example Door panels, decorative trims, arm rests, central console, dashboards, glove boxes, seats. Either or both the shaped article and the sliding member may be made by injection moulding.

The sliding member may or may not also be made of a thermoplastic material or thermoplastic material. When the sliding member is made of a thermoplastic material or thermoplastic elastomeric material, said material may be the same as the material from which the shaped article is made. Alternatively the sliding member may be made from a non-plastic material such as a metal or leather.

The assembly as hereinbefore described may consist of the shaped article and the sliding member. However, the shaped article and the sliding member may alternatively form part of a multi-part assembly or the shaped article and the sliding member may be parts in frictional contact moving relative to each other in the form of internal parts of the assembly. For example, the shaped article and the sliding member may be linked together by a fastening mechanism such as nuts and bolts or screws or alternatively may be clipped together. For example a part of the shaped article may be designed to be received (clipped) into a receiver in the sliding member or vice versa.

By being in frictional contact it is to be understood that the shaped article and the sliding member, during their functional lifetime (and that of the assembly) are subjected to frictional movement relative to each other being required to overcome kinetic frictional forces in order to continue moving. Whilst historically the shaped article and the sliding member would have regularly succumbed to the stick-slip phenomenon and associated noises, e.g. squeaking and the like, the presence of the contents of the masterbatch as hereinbefore described enable the shaped article and the sliding member to move relative to each other with significantly reduced occurrence of the stick-slip phenomenon and related noises.

Hence for example, the assembly is typically made out of a thermoplastic sliding member made from a first thermoplastic material by injection moulding which is not modified with the masterbatch as hereinbefore described and a the shaped article is made from a second thermoplastic material incorporating a masterbatch as hereinbefore described with the aforementioned shaped article and the sliding member clipped or assembled together in frictional contact the squeaking noise and stick-slip phenomenon occurrences are significantly reduced or completely avoided. The present invention allows for the efficient replacement of traditional anti-squeaking coatings, external greases and felt, production flexibility, improved wear resistance, use during compounding or injection molding, reduced design cost, good surface finishing. The present invention is particularly well suited for PC/ABS blends.

### EXAMPLES

The invention is illustrated by the following examples, in which parts and percentages are by weight unless otherwise stated.

Silicone rubber masterbatches were prepared using two silicone rubber bases in the amounts depicted in Table 1 below using the materials described.
i) Si-rubber base 1 is an uncatalysed Silicone Rubber Base of 70 Shore A hardness (measured in accordance with ASTM D2240-03) comprising a blend of organopolysiloxane gums, and silica filler. The blend of gums is a mixture of vinyldimethyl terminated polydimethylsiloxane, vinyldimethyl terminated polydimethyl methylvinyl siloxane copolymer gum and a trimethyl terminated polydimethyl methylvinyl siloxane copolymer. The gum has a specific gravity of 1.23 and the gum blend has a Williams Plasticity number comprised between 300 and 450 mm/100, measured in accordance with ASTM D-926 - 08.
ii) The silica used as reinforcing filler is a fumed (pyrogenic) silica with a particle size comprised in the range of 0.5 μm to 20 μm size, such as that sold by Cabot under the trade mark Cab-O-Sil MS-75D. The silica is pretreated with an oligomeric organopolysiloxane, containing vinylmethylsiloxane unit and silanol terminal groups.
iii) Si-rubber base 2 is an uncatalysed Silicone Rubber Base of 40 Shore A hardness (measured in accordance with ASTM D2240-03 comprising a blend of organopolysiloxane gums, and silica filler. The blend of gums is a mixture of vinyldimethyl terminated polydimethylsiloxane, vinyldimethyl terminated polydimethyl methylvinyl siloxane copolymer gum and a trimethyl terminated polydimethyl methylvinyl siloxane copolymer. The gum has a specific gravity of 1.11 and blend has a Williams Plasticity number comprised between 150 and 200 mm/100, measured in accordance with ASTM D-926 - 08.
iv) The silica used as reinforcing filler is a fumed (pyrogenic) silica with a particle size comprised in the range of 0.5 μm to 20 μm size, such as that sold by Cabot under the trade mark Cab-O-Sil® MS-75D. The silica is pretreated with an oligomeric organopolysiloxane, containing vinylmethylsiloxane unit and silanol terminal groups.
v) The Platinum catalyst used in the examples was DowSil® Syl-Off® 4000 catalyst from the Dow Chemical Company, Midland Mich.
vi) The cross-linker used in the examples was DowSil® Syl-Off® 7678 Crosslinker, from the Dow Chemical Company, Midland, Mich.
vii) The ethylene acrylate copolymer used was Elvaloy® AC 1609 from Dupont which has a co-monomer content of 9wt %, an MFI of 6 g/10′ (190° C./2,16 kg), a density of 0.93, a vicat softening point of 70° C. and a melting temperature of 101° C.
viii) The anti-oxidant used was Irganox® 1010 from BASF, a sterically hindered phenolic antioxidant.

The composition utilised are depicted in Table 1.

TABLE 1

| | Si-MB 1 | Si-MB 2 | Si-MB 3 | Si-MB 4 |
|---|---|---|---|---|
| Si-Rubber 1 | 48.246 | | 50 | |
| (wt. %) | | | | |
| Si-Rubber 2 | | 48.847 | | 50 |
| (wt. %) | | | | |
| Pt catalyst | 0.257 | 0.243 | | |
| (wt. %) | | | | |
| Si—H cross | 1.497 | 0.91 | | |
| linker (wt. %) | | | | |
| Thermoplastic | 49.9 | 49.9 | 49.9 | 49.9 |
| phase (wt. %) | | | | |
| Anti-oxidant | 0.1 | 0.1 | 0.1 | 0.1 |
| (wt. %) | | | | |

The mixing of components and the silicone vulcanization reaction was carried out using a twin screw extruder, 25 mm of diameter and 48 L/D. The twin screw extruder processing barrel sections were heated up in a range from 160° C. up to 180° C. (from 180° C. up to 200° C. at the die). The ethylene acrylate copolymer was fed into the main extruder entry port and melted as it passed through the extruder. Downstream, the silicone base, platinum catalyst and Si—H crosslinker were individually introduced into the melted ethylene acrylate copolymer to ensure even distribution and dynamic vulcanization reaction of the silicone base to form a silicone elastomer in the melted ethylene acrylate copolymer. The location of each individual injection port is set in order to ensure the silicone vulcanization reaction is completed within the residence time of the ethylene acrylate copolymer in the extruder. In the case of examples using uncured silicone base rubber, the platinum catalyst and Si—H cross linker were not introduced into the extruder. The resulting product was pelletized.

The resulting pelletized masterbatch product was dried at 110° C. for 2 hours to reach a max relative humidity by 0.02%.

The resulting silicone masterbatches in pellet form were then dry blended at the required ratio together with a 70% by weight polycarbonate (PC) and 30% by weight acrylontrile butadiene styrene (ABS) thermoplastic blend sold under the name of Bayblend® T85XF from Covestro AG of Leverkusen, Germany and compounded through a melt mixing process using a co-rotating twin screw extruder with the characteristic's D20 and L/D 40. The processing temperature are set between 230 and 250° C. with a screw speed of 200rpm and a throughput of 2.5kg's/hour. The PC/ABS blend had also been pre-dried at 110° C. for 3 hours to reach a max relative humidity by 0.02% prior to introduction in the extruder.

The above were compared with four Comparative materials:
COMP-1: An unmodified PC/ABS (30% ABS)—the material modified in the examples by introduction of the masterbatches described above. COMP-1 is used as a reference or base-line. The COMP-1 material was dried for 3 hours at 110° C. prior to injection moulding.
COMP-2: Hushlloy® HS-210—a commercially available anti-squeaking PC-ABS grade from Techno Polymer Co Limited. it is understood that this is a chemically modified ready to use PC/ABS based on copolymerization technologies which provides anti stick-slip/anti-squeaking behaviour by delivering a high “stick” behaviour to prevent parts moving from each other.
COMP-3: Molykote® D96 UV anti friction coating a fluoro based UV-curable anti-squeaking coating. This water based coating contains 42% of PTFE. This coating is an Anti-noise, Anti-friction Coating for automotive industry (interior application) that can be sprayed or brushed. Perfluoro based coatings are best in class solution for anti-squeaking. The anti-squeaking process is delivered by dramatically decreasing static and dynamic coefficient of friction of the coated part against its counter-part. Plates of PC/ABS (30% by weight ABS) material were first cleaned with L-13 cleaner and then coated with a layer of the anti-friction coating with a thickness of approximately 20 μm. Plates were put in oven for a period of 5 minutes at 50° C. and cured under UV.
COMP-4: a compounded PC/ABS in which a trimethyl siloxy terminated polydimethylsiloxane (PDMS) with a kinematic viscosity at 25° C. of 1000 mm²·s⁻¹ (cSt) (measured as per ASTM D445-17a) was prepared with a 2wt % loading of the PDMS. The material was prepared by twin screw extrusion process using liquid injection. The material was dried for 3 hours at 110° C. prior to injection moulding. PDMS is a well-known and highly efficient lubricant which has been used to minimise the squeaking noise with respect to some thermoplastic materials. However, it could be seen that the PDMS used was not very compatible with PC/ABS thermoplastic material being used in the examples—significant bleeding was observed upon injection and the surface of injection moulded parts were not homogenous and non-aesthetic with a strong oily feeling and aspect. It was also noticed that the PDMS was washed out with time as non-embedded in the host matrix.

Once prepared as described above the examples materials and comparative materials were injection moulded, typical injection temperatures were between 230-250° C., using a back pressure of 150bar (15000000 Nm⁻²), an injection speed of 0.35 m/s and a mould temperature of 70° C.

### Stick-Slip/Squeaking Evaluations:

Squeak test was performed on an SSP04 Stick-slip test bench from Ziegler Instruments GmbH following VDA 230-206: 2007 (Examination of the stick-slip behaviour of Material Pairs Part 1 to 3) in which a flat sample plate of an injection moulded example/counter example under test (dimensions of 100×100×4 mm) was slid across a flat rectangular piece of non-modified injection moulded PC/ABS (dimensions 25×50 mm) using the test parameters indicated as follows in Table 2:

TABLE 2

| Temperature | 23 (+−2° C.) | |
|---|---|---|
| Relative Humidity | 50% (+−5%) | |
| Moving Plates | 25 × 50 | mm |
| Speed | 4 | mm/s |
| Load | 40 | N |
| Movements/cycle (back and forth) | 4050 | |
| Length/movement | 5 | mm |

The SSPO4 Stick-slip test bench provides several results from the practical assessment:

The Risk Priority Number or RPN provides a number which gives the probability of a pair of materials giving an audible squeaking noise in accordance with VDA 230-206: 2007 (ASTM 230-206). An RPN between 1 and 3 identifies material pairs with no or minimal squeaking risk. An RPN of from 4 to 5 represents grades where no squeaking is registered but the material pair may deliver squeaking on a long term. Finally grades above 5 i.e. between 5 and 10 identify material pairs delivering audible squeaking noise.

The impulse value provides the number of stick-slip occurrences between the 2 surfaces (start-stop) during the test. Anti-squeaking additives are targeting the lower impulse values. Maximum Acceleration: acceleration recorded during the restart phases of each stick-slip phenomenon. The high the Max. Acceleration is, the worst the stick-slip phenomenon will be and the higher the risk of noise generation will be.

Static coefficient of friction (SCOF) is defined as the longitudinal force to be applied in parallel to the displacement to induce the movement.

Dynamic coefficient of friction (DCOF) is defined as the longitudinal force needed to keep one surface moving against the other with a constant speed.

The surface appearance by visual inspection of the test samples were graded as good (no visible traces of products demix or flow marks), poor (Visible flow marks) or bloom (product demixing with surface flow marks and non-homogeneity). The examples and counter examples were also visually studied for evidence of Surface abrasion (surface damage and scratches) after stick-slip test and of course it was noted if/when any audible noise was identified during the test procedure.

All results will be expressed as the mean average of the 3 independent samples on which 10 cycles (405 movements back and forth/cycle; total of 4050 movements) have been performed. The unmodified PC/ABS went through the same processing sequences (extrusion and injection moulding) as the test samples to follow the same thermic history. Comp 3, the commercial ready to use PC/ABS was directly injected into the testing moulds. The compounded materials were prepared including 4% by weight of masterbatch or in the case of Comp 4, PDMS as indicated in Table 3 below.

The compounded formulations utilised for the testing are listed as in Table 3 below:

TABLE 3

| In wt % | Ex-1 | Ex-2 | Ex-3 | Ex-4 | COMP-4 |
|---|---|---|---|---|---|
| PC/ABS | 96 | 96 | 96 | 96 | 98 |
| Si-MB-1 | 4 | | | | |
| Si-MB-2 | | 4 | | | |
| Si-MB-3 | | | 4 | | |
| Si-MB-4 | | | | 4 | |
| PDMS (1000 | | | | | 2 |
| mm² · s⁻¹ | | | | | |
| Comments | X-linked | X-linked | Non | Non | 1000 |
| | high shore | low shore | X-linked | X-linked | mm² · s⁻¹ |
| | Si-base | Si-base | high shore | low shore | Silicone |
| | Si-MB | Si-MB | Si-base | Si-base | oil |
| | | | Si-MB | Si-MB | |

In the examples herein Ex-1 and Ex-2 exemplified the vulcanized silicone masterbatches and Ex-3 and Ex-4 are their non vulcanized counter parts.

### Experiment 1

This was performed to show that the product from the present invention and presented under Ex-1 is working in the same way under comparable conditions to the current benchmark product and technical approaches exemplified by ComEx-2 and ComEx-3.

TABLE 4

| Values | | | | |
|---|---|---|---|---|
| (Std dev) | Ex-1 | CompEx-1 | CompEx-2 | CompEx-3 |
| Surface | Good | Good | Good | Good |
| appearance* | | | | |
| RPN** | 1.2 (0.3) | 9.7 (1.1) | 1.1 (0.2) | 1.1 (0.14) |
| Max | 0.14 (0.15) | 6.4 (1.3) | 0.13 (0.04) | 0.08 (0.05) |
| acceleration | | | | |
| (g) | | | | |
| Impulse | 327 (91) | 14800 (2500) | 78 (96) | 516 (51) |
| (counts) | | | | |
| Static | 0.18 (0.02) | 0.41 (0.03) | 0.34 (0.04) | 0.1 (0.001) |
| COF | | | | |
| Dynamic | 0.17 (0.02) | 0.35 (0.02) | 0.3 (0.02) | 0.09 (0.001) |
| COF | | | | |
| Surface | Very Light | Very high | Light | Very Light |
| abrasion | | | | |
| visible?* | | | | |
| Audible | No | Yes | No | No |
| noise | | | | |
| generation | | | | |

As anticipated the non-modified PC/ABS CompEx-1 had a very high RPN classification, the highest values for both static and dynamic coefficient of friction (COF) as well as a high frequency of stick-slip occurrences indicated by the impulse value, 14800 and a Max Acceleration at 6.4. The surface of the CompEx-1 sample under test could be seen to have significant abrasion damage which to an extent resulted in the presence of polymeric powder on the surface after being tested due to the surface abrasion. Finally, it generated audible noises during the test.

The best in class benchmarking CompEx-3 shows excellent results. The coating is delivering anti-squeak performance by delivering a very low COF between the material pairs. A very low RPN was identified (close to 1 in average), together with providing the lowest static and dynamic COF results, respectively at 0.1 and 0.09. The impulse rate was 516 together which together with a low Max acceleration of 0.08 contributes also to absence of noise generation.

CompEX-2, the commercial ready to use modified PC/ABS compound, delivered good stick-slip performances with no stick-slip development. However, this compound did show high COF values, close to the original PC/ABS matrix which could pose some issues in typical applications where a good gliding effect would be required.

Ex-1, the result of compounding a thermoplastic silicone vulcanisate masterbatch into the PC/ABS has an excellent RPN value at 1.2, comparable to CompEx-2 and CompEx-3 and well below the maximum acceptable RPN value tolerated of 3. Ex-1 as hereinbefore described has performance values comparable to CompEx-2 with slightly lower impulse and COF values, making it more suitable in our view than CompEx-2 being closer results wise to said CompEx-3 considered to be best in class.

### Experiment Part 2

A second series of trials was performed looking at broader scope.

TABLE 5

| Values | | | | | Comp | Comp | Comp | Comp |
|---|---|---|---|---|---|---|---|---|
| (Sdt dev) | Ex-1 | Ex-2 | Ex-3 | Ex-4 | Ex-1 | Ex-2 | Ex-3 | Ex-4 |
| Surface | Very | Very | Good | Not | Good | Good | Good | Bloom** |
| appearance | Good | Good | | Good | | | | |
| RPN | 2.4 | 2 | 4.3 | 2.3 | 9.7 | 1.1 | 1 | 2.8 |
| | (0.64) | (0.2) | (1.1) | (0.6) | (1.1) | (0.21) | (0.1) | (1.6) |
| Max | 0.58 | 0.26 | 1.53 | 0.5 | 6.4 | 0.1 | 0.1* | 0.72 |
| acceleration | (0.25) | (0.1) | (1.21) | (0.3) | (1.3) | (0.01) | (0.02) | (0.56) |
| (g) | | | | | | | | |
| Impulse | 784 | 933 | 4292 | 613 | 14800 | 135 | 0* | 1030 |
| (counts) | (256) | (114) | (1816) | (347) | (2500) | (61) | | (282) |
| SCOF | 0.2 | 0.19 | 0.21 | 0.12 | 0.41 | 0.2 | Not | 0.06 |
| | (0.01) | (0.04) | (0.03) | (0.03) | (0.03) | (0.01) | measured* | (0.008) |
| DCOF | 0.18 | 0.17 | 0.18 | 0.1 | 0.35 | 0.1 | 0.1* | 0.05 |
| | (0.01) | (0.03) | (0.03) | (0.03) | (0.02) | (0.01) | (0.003) | (0.0075) |
| Surface | Very | Very | Light | Not | Very | Light | Very | Light |
| abrasion | light | light | | visible | high | | Light | |
| visible? | | | | | | | | |
| Audible | No | No | No | No | Yes | No | No | No |
| noise | | | | | | | | |
| generation | | | | | | | | |

*ComEx-3: Material not gliding against each other upon testing. As such, Impulse is 0 and Static and Dynamic COF as well as Max acceleration are not representative values from the testing.
**surface aspect heavily impacted due to surface swelling of the PDMS.

Ex-1 and Ex-2 are respectively the crosslinked Si-MB's containing a high and low shore-A base gum. Ex-3 and Ex-4 are the corresponding non cross-linked Si-MB's of the high and low shore A base gum. It has been interesting to discover that cross linking is required for high shore A based gum Si-MB' s in order to deliver anti-squeaking performances. Indeed, the non cross-linked high shore A silicone based Si-MB, represented by Ex-3, did not show acceptable anti-squeaking performances as a RPN of 4.3 was obtained, together with higher impulse and Max acceleration. As such, this Ex-3 is not fulfilling the requirement of the present invention as it clearly showed RPN numbers above limits of 3, which is the limit defined by VDA 230-206 to consider a material pair as anti-squeaking.

On the contrary, the low shore silicone base Si-MB showed good anti-squeaking performances both for the cross-linked and the non cross-linked additive, represented respectively by Ex-2 and Ex-4. However, surface aspect is dramatically improved by the cross-linking process as Ex-2 did show excellent surface aspect while Ex-4 did not show good surface aspect.

As expected Comp-Ex4 showed some anti-squeaking performance with an RPN in an average at the limit value of 2.8. The bad dispersion of PDMS and surface inhomogeneity is exemplified by the high standard variation measured on the RPN number, showing a low repeatability of the measurement. On the other side, surface was heavily impacted by PDMS blooming upon injection. Surface is very greasy and non-aesthetics, making it not suitable for automotive visible parts applications. On top, PDMS are liquids making them not used friendly. This is where Ex1, 2 and 4 from present invention are delivering very good anti-squeaking performances with excellent surface aspect while being easier to use (pellets).

1. A shaped article of a thermoplastic material comprising a blend of
(A) one or more thermoplastic organic materials, with
(B) a masterbatch of a stick-slip modifier comprising
(B1) one or more thermoplastic organic materials,
(B2) a silicone elastomer; and/or
(B3) an uncured organopolysiloxane polymer
in which masterbatch (B) there is contained a total of from 20% to 60% by weight of components (B2)+(B3) based on the weight of (B1)+(B2)+(B3) and in which thermoplastic elastomer composition there is a total of from 0.2 to 25% by weight of cross-linked silicone elastomer based on the weight of (A)+(B).

2. A shaped article in accordance with claim 1 comprising component (B2) and optionally component (B3).

3. A shaped article in accordance with claim 2 wherein uncured organopolysiloxane (B3) is present in an amount of from 0.1 to 25% by weight of masterbatch (B).

4. A shaped article in accordance with claim 1 wherein Silicone elastomer (B2), when present, is prepared by dynamic vulcanisation of:
diorganopolysiloxane (B2a1) having an average of at least two alkenyl groups per molecule and either
(i) an organopolysiloxane having at least two Si-bonded hydrogen atoms, alternatively at least three Si-bonded hydrogen atoms per molecule (B2a2) and a hydrosilylation catalyst (B2a3) and optionally a catalyst inhibitor (B2a5); or
a radical initiator (B2a4); or
a silanol terminated diorganopolysiloxane (B2b1),
organopolysiloxane having at least two Si-bonded hydrogen atoms, alternatively at least three Si-bonded hydrogen atoms per molecule (B2a2) and
a condensation catalyst (B2b3).

5. A shaped article in accordance with claim 4 wherein diorganopolysiloxane (B2a1) or diorganopolysiloxane (B2b1) is a gum having a Williams plasticity value of at least 100mm/100 as measured by ASTM D-926-08.

6. A shaped article in accordance with claim 1 wherein the one or more thermoplastic organic materials (A) and (B1) may be the same or different and are selected from polycarbonates (PC); blends of polycarbonates with other polymers; polyamides and blends of polyamides with other polymers; polyesters; polyphenylene ether (PPE) and polyphenyleneoxide (PPO), and blends of PPE or PPO with styrenics; polyphenylene sulphide (PPS), polyether sulphone (PES), polyaramids, polyimides, phenyl-containing resins having a rigid rod structure, styrenic materials; polyacrylates, SAN; halogenated plastics exemplified by; polyketones, polymethylmethacrylate (PMMA), Polyolefins as well as , copolymers and blends of polyolefin; thermoplastic elastomers such as thermoplastic urethanes, thermoplastic polyolefinic elastomers, thermoplastic vulcanizates; styrene ethylene butylene styrene (SEBS) copolymer, natural products such as cellulosics, rayon, and polylactic acid and mixtures thereof.

7. A shaped article in accordance with claim 6 wherein the one or more thermoplastic organic materials (A) and (B1) may be selected from polyesters, polycarbonates;
blends polycarbonate-acrylonitrile-butadiene-styrene (PC/ABS) blends, polycarbonate-polybutylene terephthalate (PC/PBT) blends; polycaprolactam (Nylon-6), polylauryllactam (Nylon-12), polyhexamethyleneadipamide (Nylon-6,6), polyhexamethylenedodecanamide (Nylon-6,12), poly(hexamethylene sebacamide (Nylon 6,10), polybutylene terephthalate (PBT), polyethylene terephthalate (PET), and polyethylene naphthalate (PEN); polyphenylene ether (PPE) and polyphenyleneoxide (PPO), and blends of PPE or PPO with styrenics such as high-impact3 polystyrene (HIPS), polystyrene, acrylonitrile-butadiene-styrene-(ABS) and styrene acrylonitrile resins (SAN); polyphenylene sulphide (PPS), polyether sulphone (PES), polyaramids, polyimides, ABS (acrylonitrile-butadiene-styrene), polystyrene (PS) HIPS; polyacrylates, SAN; polyvinyl chloride, fluoroplastics, and any other halogenated plastics; polyketones, polymethylmethacrylate (PMMA), polypropylene (PP), polyethylene (PE), high density polyethylene (HDPE) and low density polyethylene (LDPE), polybutene (PB) as well as copolymers and blends of polyolefin, thermoplastic urethanes, thermoplastic polyolefinic elastomers, thermoplastic vulcanizates; and styrene ethylene butylene styrene (SEBS) copolymer.

8. A shaped article in accordance with claim 6, wherein the one or more thermoplastic organic materials (A) and (B1) may be selected from polybutylene terephthalate (PBT), polyethylene terephthalate (PET), polyethylene naphthalate (PEN), polycarbonate, ABS (acrylonitrile-butadiene-styrene), polystyrene (PS), and high-impact polystyrene (HIPS), polyacrylates, styrene-acrylonitrile resins (SAN) and any blends thereof.

9. A shaped article in accordance with claim 1 wherein the shaped article is an automobile part such as a housing, latch, window winding system, wiper part, sun roof part, lever, bush, gear, gear box part, pivot housing, bracket, zipper, switch, cam, sliding element or plate and as a part of door panel decorative trims, arm rests, central console, dashboards, glove boxes, seats and/or a combination of parts in frictional contact with the sliding member.

10. An assembly comprising:
a shaped article in accordance with claims 1 in frictional contact with a sliding member, the shaped article and the sliding member being configured to remain in frictional contact and move relative to each other.

11. An assembly in accordance with claim 10 wherein the sliding member is a second shaped article in accordance with claim 1.

12. An assembly in accordance with claim 10 wherein the sliding member is a non-plastic material.

13. An assembly in accordance with claim 10 wherein the assembly is door panel decorative trims, arm rests, central console, dashboards, glove boxes, seats or a combination of parts in frictional contact including the shaped article and sliding member.

14. A method for making a shaped article in accordance with claim 1 comprising making a masterbatch of a stick-slip modifier (B) comprising
(B1) one or more thermoplastic organic materials,
(B2) a silicone elastomer; and/or
(B3) an uncured organopolysiloxane polymer
(i) by blending uncured organopolysiloxane polymer (B3) and/or the components used to produce silicone elastomer (B2) silicone composition with one or more thermoplastic organic materials (B1),
(ii) when the silicone elastomer (B2) is being made, dynamically vulcanising the silicone composition to form silicone elastomer (B2), and/or
(iii) when the silicone elastomer (B2) is being made, introducing (B3), during step (ii) or after step (iii);
in which masterbatch (B) there is contained from a total of from 20% to 60% by weight of components (B2)+(B3) based on the weight of (B1)+(B2)+(B3) and in which thermoplastic elastomer composition there is a total of from 0.2 to 25% by weight of cross-linked silicone elastomer based on the weight of (A)+(B) and shaping the thermoplastic material to form a shaped article.

15. A method in accordance with claim 14 wherein the shaped article is shaped by extrusion, vacuum forming, injection moulding, blow moulding, 3D printing or compression moulding, to fabricate plastic parts.

16. A method of making an assembly comprising making a shaped article in accordance with claim 14 and fixing or placing said shaped article in frictional contact with a sliding member, the shaped article and the sliding member being configured to remain in frictional contact and move relative to each other.

17. Method of reducing the occurrence of stick-slip interactions of a thermoplastic material comprising combining a a thermoplastic silicone vulcanisate with a masterbatch.

18. A shaped article of a thermoplastic material in accordance with claim 1 wherein the thermoplastic material is a thermoplastic elastomeric material.
